(19) United States
(12) Patent Application Publication
(10) Pub. No.: US 2025/0076676 A1
(43) Pub. Date: Mar. 6, 2025

(54) OPTICAL STABILIZATION STRUCTURE

(71) Applicant: Luxshare Intelligent Manufacture Technology (Changshu) Co.,Ltd, Changshu City (CN)

(72) Inventors: Po-Ying TSENG, Taipei City (TW); Tao-Chun CHEN, Taipei City (TW)

(73) Assignee: Luxshare Intelligent Manufacture Technology (Changshu) Co.,Ltd, Changshu City (CN)

(21) Appl. No.: 18/815,340

(22) Filed: Aug. 26, 2024

(30) Foreign Application Priority Data
Aug. 31, 2023 (CN) 202311113539.3

(51) Int. Cl. G02B 27/64

(52) U.S. Cl. CPC G02B 27/64

(57) ABSTRACT

An optical stabilization structure, which includes a fixing component and a movable component, is disclosed. The fixing component provides an accommodating space, and includes a bottom plate and a first annular sidewall. The bottom of the first annular sidewall is orthogonally connected to the bottom plate to constitute the accommodating space, and an inner sidewall of the first annular sidewall has a contact surface. The movable component includes a second annular sidewall disposed in the accommodating space, wherein an outer sidewall of the second annular sidewall has an abutting surface, the abutting surface matches the contact surface by point contact, and the abutting surface is configured to be slidable relative to the contact surface. Through the contact manner of the movable component and the fixing component, the contact position, area and force of the optical stabilization structure are more stable to achieve the purpose of enhancing product performance.

### CROSS REFERENCE TO RELATED APPLICATION

This application claims the priority benefit of Chinese Patent Application Serial Number 202311113539.3, filed on Aug. 31, 2023, the full disclosure of which is incorporated herein by reference.

### BACKGROUND

### Technical Field

The present application is related to a technical field of optics, and is particularly related to an optical stabilization structure.

### Related Art

The optical stabilization structure of the prior art includes a movable component and a fixed component. The fixed component is encased in the movable component so that the movable component is disposed inside the fixed component. But the movable component contacts the fixed component by arc surfaces, and in other words, the arc surface of the movable component corresponds to the arc surface of the fixed component.

However, the contact of the movable component and the fixed component by arc surfaces influences optical stabilization performance of an optical stabilization device due to instability of contact positions or contact areas during the operation of the optical stabilization device.

Therefore, there is a need for further improvement in the prior art to provide a more optimal solution.

### SUMMARY

In view of the deficiencies in the prior art, the main purpose of the present application is to provide an optical stabilization structure. In the optical stabilization structure, by improving the contact manner between the movable component and the fixing component, the contact position or contact area is stabilized to enhance the performance of the product.

In order to achieve the aforementioned purpose, the main technical means is the technical features of the optical stabilization structure provided by the present application as follows:
a fixing component providing an accommodating space, and the fixing component including:
a bottom plate;
a first annular sidewall of which a bottom is adjacent to the bottom plate, wherein the bottom of the first annular sidewall is orthogonally connected to the bottom plate to constitute the accommodating space, and an inner sidewall of the first annular sidewall has a contact surface;
a movable component disposed in the accommodating space, and including:
   a second annular sidewall disposed in the accommodating space, wherein an outer sidewall of the second annular sidewall has an abutting surface;
wherein the abutting surface matches the contact surface by point contact, and the abutting surface is configured to be slidable relative to the contact surface.

Preferably, the contact surface is a plane, and the abutting surface is a spherical surface.

Preferably, the contact surface is a spherical surface, and the abutting surface is a plane with a protruding point.

Preferably, the second annular sidewall comprises an upper annular sidewall and a lower annular sidewall, the upper annular sidewall has an upper trench, the lower annular sidewall has a lower trench, and an opening of the upper trench matches an opening of the lower trench to constitute an accommodating part.

Preferably, the optical stabilization structure further includes an elastic piece disposed on the fixing component and contacting the abutting surface elastically.

Preferably, one end of the elastic piece is disposed on the fixing component and extends toward an outer sidewall of the second annular sidewall, and the elastic piece bends to constitute a bend part accordingly, and after constituting the bend part, the elastic piece extends along the outer sidewall of the second annular sidewall to constitute an another end of the elastic piece.

Preferably, the another end of the elastic piece has an elastic abutting surface which is a plane, the abutting surface contacts the elastic abutting surface by the point contact, and the abutting surface is configured to be slidable relative to the elastic abutting surface.

Preferably, a number of elastic piece is three, and the three elastic pieces are equidistant from each other; a number of contact surfaces is three, and the three contact surfaces are equidistant from each other.

Preferably, the first annular sidewall has a fixing part, the fixing part is constituted by recessing from a top of a part of the first annular sidewall to the bottom of the first annular sidewall, the contact surfaces is disposed on an inner sidewall of the fixing part, and the elastic piece is disposed on a top of the fixing prat.

Preferably, the elastic piece includes a through hole disposed at the bend part and passing through a portion of the bend part.

Preferably, abutting surface comprises an upper abutting surface and a lower abutting surface, the upper abutting surface extends from a top of the second annular sidewall to the lower abutting surface, the lower abutting surface extends from a bottom of the second annular sidewall to the upper abutting surface, the upper abutting surface and the lower abutting surface cooperatively form the spherical surface, the upper abutting surface contacts the elastic abutting surface by the point contact, and the contact surface contacts the lower abutting surface.

Preferably, the first annular sidewall has a coil insertion part and a coil embedding part, the coil insertion part is constituted by recessing from a portion of the top of the first annular sidewall to the bottom of the first annular sidewall, and the coil embedding part is constituted by passing through the first annular sidewall.

Preferably, the coil embedding part and the coil insertion part are relatively disposed, and the coil insertion part and the coil embedding part are positioned between the fixing part, and the coil insertion part and the coil embedding part correspond to the accommodating part.

Preferably, the optical stabilization structure further includes:
a plurality of coils, wherein some of the plurality of coils are inserted in the coil insertion part and some of the plurality of coils are embedded in the coil embedding part; and
a plurality of sets of magnetic elements disposed on the accommodating part.

Preferably, some of the plurality of sets of magnetic elements are orthogonally disposed with the second annular sidewall in the accommodating part, and some of the plurality of sets of magnetic elements are horizontally disposed with the second annular sidewall in the accommodating part.

Preferably, some of the plurality of sets of magnetic elements are orthogonally disposed with the second annular sidewall in the accommodating part and corresponds to the coil insertion part, and some of the plurality of sets of magnetic elements are horizontally arranged with the second annular sidewall in the accommodating part and corresponds to the coil embedding part.

Through the above configuration, the fixing component and the movable component of the present application contact with each other by the point contact so that the contact position, the contact area, and the contact force are stable to achieve the purpose of enhancing product performance.

### BRIEF DESCRIPTION OF THE DRAWINGS

The accompanying drawings herein are provided to have a further understanding on the present application and constitutes a part of the present application. The schematic embodiments and the description of the present application is used to explain the present application instead of constituting inappropriate limitation. In the drawings:

FIG. 1 is a stereogram of the optical stabilization structure of the present application.

FIG. 2 is an exploded view of the optical stabilization structure of the present application.

FIG. 3 is a top view of the optical stabilization structure of the present application.

FIG. 4 is a front view of the optical stabilization structure of the present application combined with the coil.

FIG. 5 is a side view of the optical stabilization structure of the present application combined with the coil.

FIG. 6 is another side view of the optical stabilization structure of the present application combined with the coil.

FIG. 7 is a stereogram of the optical stabilization structure of the present application combined with the coil from one side.

FIG. 8 is a stereogram of the optical stabilization structure of the present application combined with the coil from another side.

FIG. 9 is an exploded view of the side view shown in FIG. 7.

FIG. 10 is an exploded view of the side view shown in FIG. 8.

### DETAILED DESCRIPTION OF THE EMBODIMENTS

The embodiments of the present disclosure will be thoroughly and clearly described below in conjunction with the accompanying drawings of the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely a part of the embodiments of the present disclosure and not all embodiments of the present disclosure. Based on the embodiments of the present disclosure, all other embodiments obtained by a person skilled in the art without inventive steps shall fall within the scope of protection of the present disclosure.

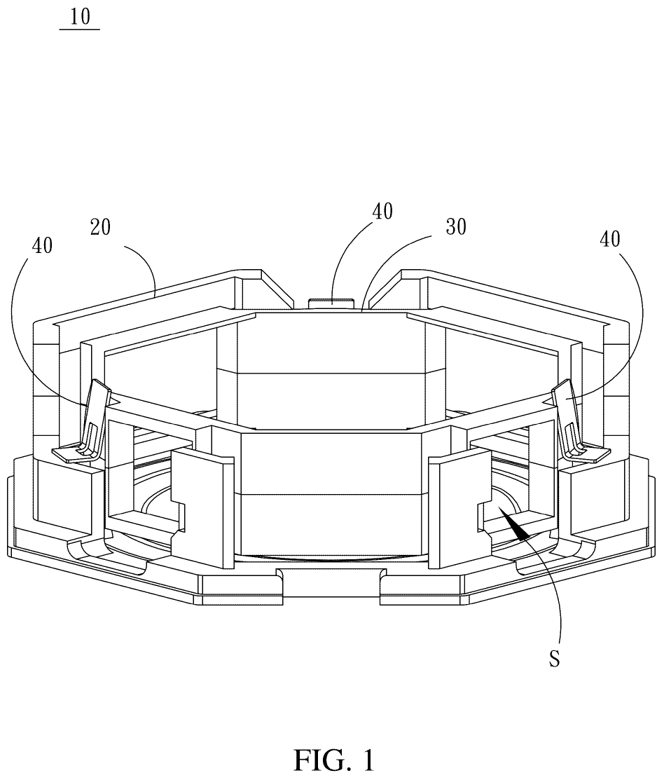

The preferred embodiment of the optical stabilization structure 10 of the present application is described as follows. As shown in FIG. 1, the optical stabilization structure 10 includes a fixing component 20 and a movable component 30. The fixing component 20 provides an accommodating space S. The movable component 30 may be slidably disposed in the accommodating space S relative to the fixing component 20, and the outer sidewall of the movable component 30 matches the inner sidewall of the fixing component 20 by point contact.

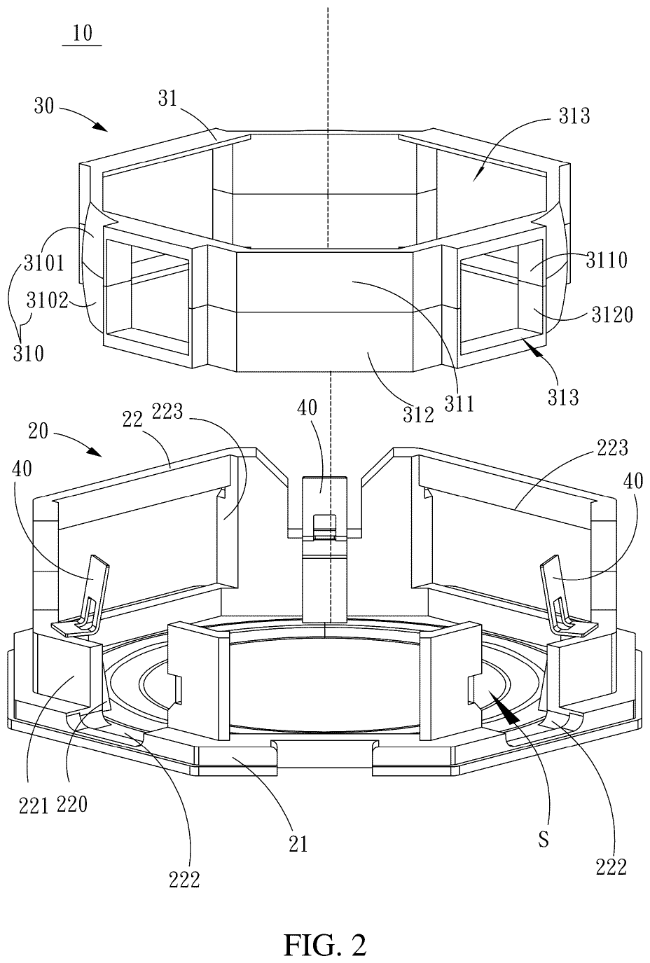

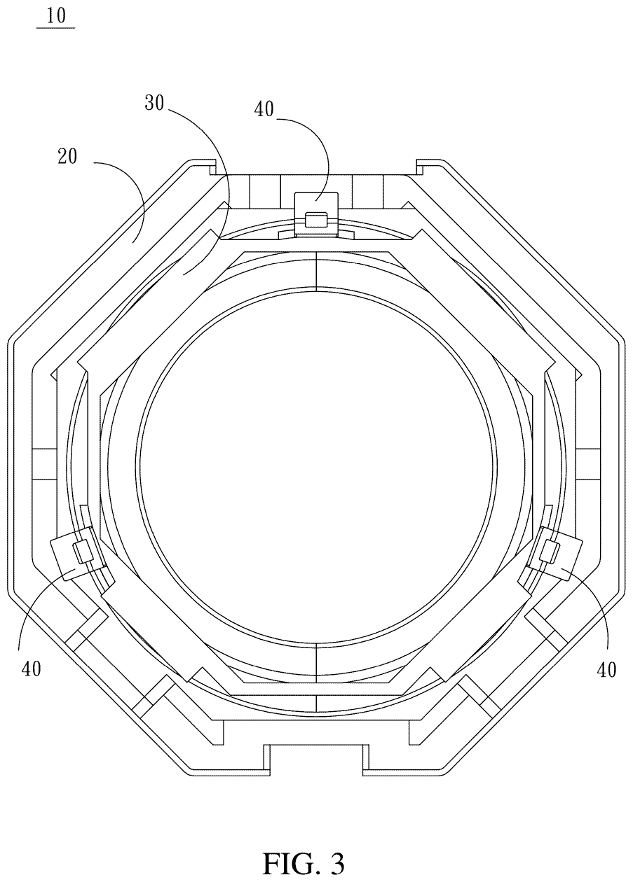

Specifically, as shown in FIG. 2 and FIG. 3, the fixing component 20 has a bottom plate 21 and a first annular sidewall 22, and the bottom of the first annular sidewall 22 is adjacent to and orthogonally connected to the bottom plate 21 so that the accommodating space S is formed between the first annular sidewall 22 and the bottom plate 21, and the inner sidewall of the first annular sidewall 22 has a contact surface 220. The movable component 30 is placed in the accommodating space S, and the movable component 30 includes a second annular sidewall 31 disposed in the accommodating space S relative to the first annular sidewall 22, and the outer sidewall of the second annular sidewall 31 has an abutting surface 310. The abutting surface 310 and the contact surface 220 contact with each other by the point contact, and the abutting surface 310 is configured to be slidable relative to the contact surface 220 so that the contact position, the contact surface and the contact force of the fixing component 20 and the movable component 30 in the optical stabilization structure 10 are more stable to achieve the purpose of enhancing the product performance.

Furthermore, the first annular sidewall 22 has a fixing part 221, a coil insertion part 222 and a coil embedding part 223, and the fixing part 221 is constituted by recessing from the top of the part of the first annular sidewall 22 to the bottom of the first annular sidewall 22. The contact surface 220 of the first annular sidewall 22 is correspondingly disposed with the inner sidewall of the fixing part 221, and the contact surface 220 is constituted by extending from a top edge adjacent to the fixing part 221 toward the bottom plate 21, and the coil insertion part 222 is constituted by recessing from a portion of the top of the first annular sidewall 22 toward the bottom of the first annular sidewall 22. Specifically speaking, the coil insertion part 222 is constituted by further recessing from the top of the fixing part 221 toward the bottom of the fixing part 221, the coil embedding part 223 is constituted by passing through the first annular sidewall 22, and the coil embedding part 223 and the coil insertion part 222 are relatively disposed, and the coil insertion part 222 and the coil embedding part 223 are disposed between the fixing part 221. In this embodiment, the contact surface 220 of the inner sidewall of the fixing component 20 is a plane with a slope. Specifically speaking, the plane with the slope is constituted by extending from the bottom plate 21 as a starting point toward the fixing part 221 at an angle greater than 90 degrees.

The movable component 30 includes a second annular sidewall 31 disposed above the bottom plate 21 and surrounded by the first annular sidewall 22, and the outer sidewall of the second annular sidewall 31 has an abutting surface 310, and the abutting surface 310 is constituted by extending from the top of the second annular sidewall 31 toward the bottom of the second annular sidewall 31 in an arc. In other words, the abutting surface 310 is a curved surface constituted by outwardly protruding. In this embodiment, the abutting surface 310 of the outer sidewall of the movable component 30 is a spherical surface. An optical camera is mounted on the inner side of the second annular sidewall 31. In this embodiment, the second annular sidewall 31 includes an upper annular sidewall 311 and a lower annular sidewall 312, the upper annular sidewall 311 has an upper trench 3110, the lower annular sidewall 312 has a lower trench 3120, and the opening of the upper trench 3110 matches the opening of the lower trench 3120 to constitute an accommodating part 313. Furthermore, the upper trench 3110 is constituted by recessing from the bottom of the upper annular sidewall 311 toward the top of the upper annular sidewall 311, and the lower trench 3120 is constituted by recessing from the top of the lower annular sidewall 312 toward the bottom of the lower annular sidewall 312. When the bottom of the second annular sidewall 311 and the top of the lower annular sidewall 312 are combined, the two ends of the opening of the upper trench 3110 and the two ends of the opening of the lower trench 3120 are correspondingly connected to constitute the accommodating part 313, and the accommodating part 313 is disposed correspondingly to the coil insertion part 222 as well as the coil embedding part 223.

In another embodiment, the contact surface 220 of the inner sidewall of the fixing component 20 is the spherical surface, and the spherical surface is constituted by protruding toward the outer sidewall of the movable component 30; the abutting surface 310 of the outer sidewall of the movable component 30 is a plane with a protruding point, and the plane with the protruding point protrudes toward the inner sidewall of the fixing component 20.

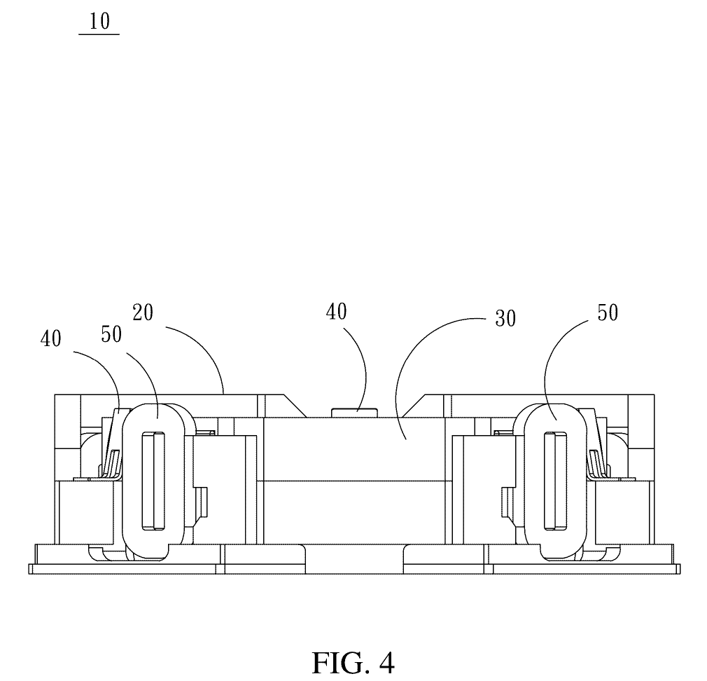

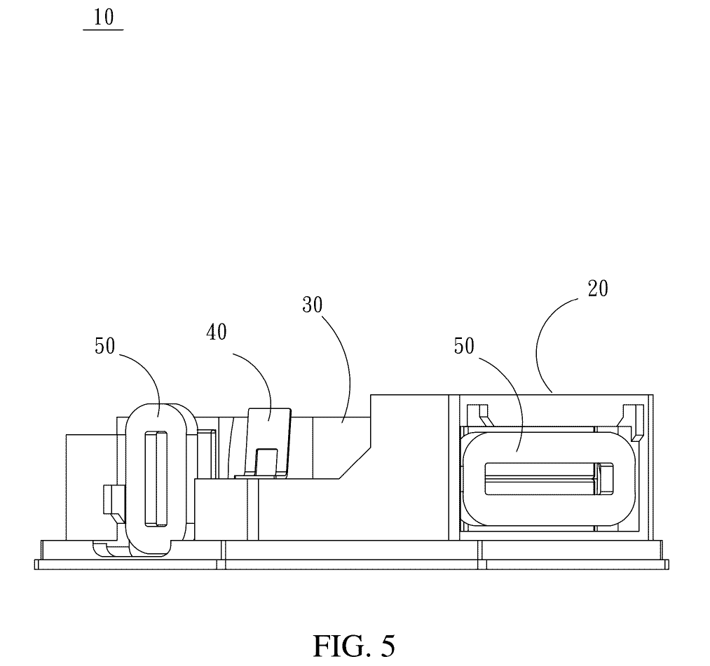

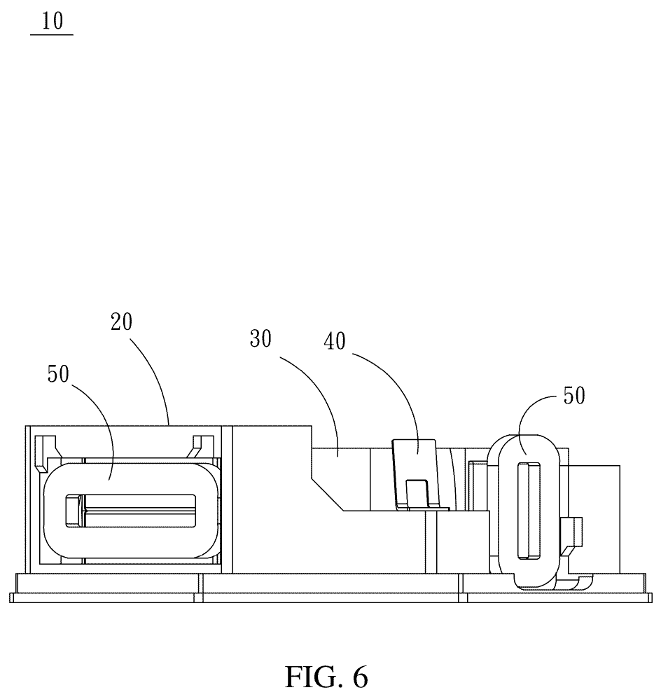

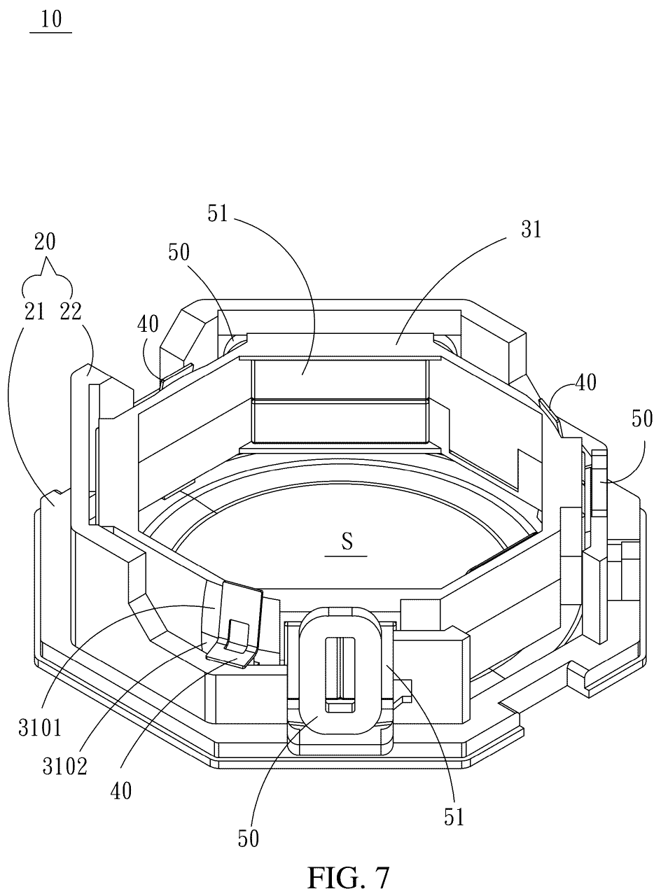

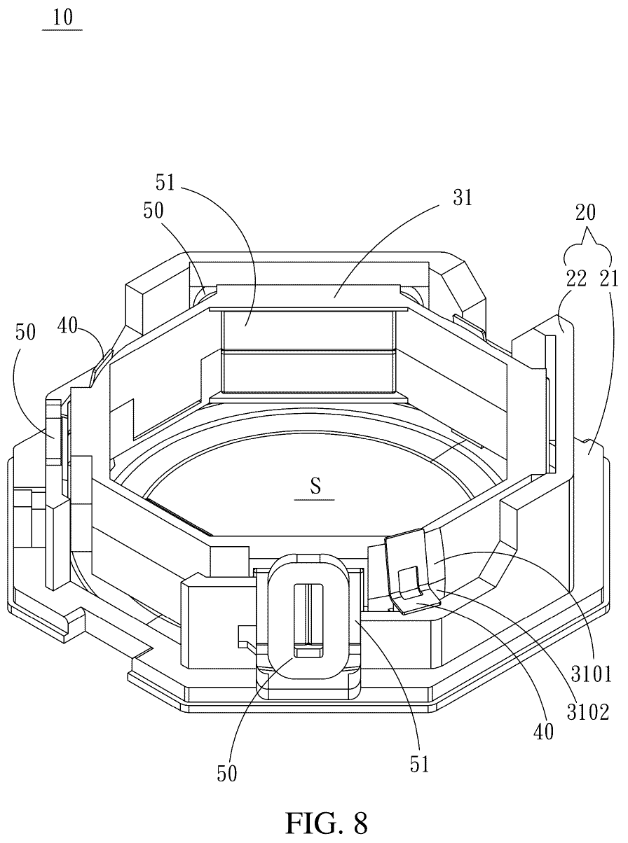

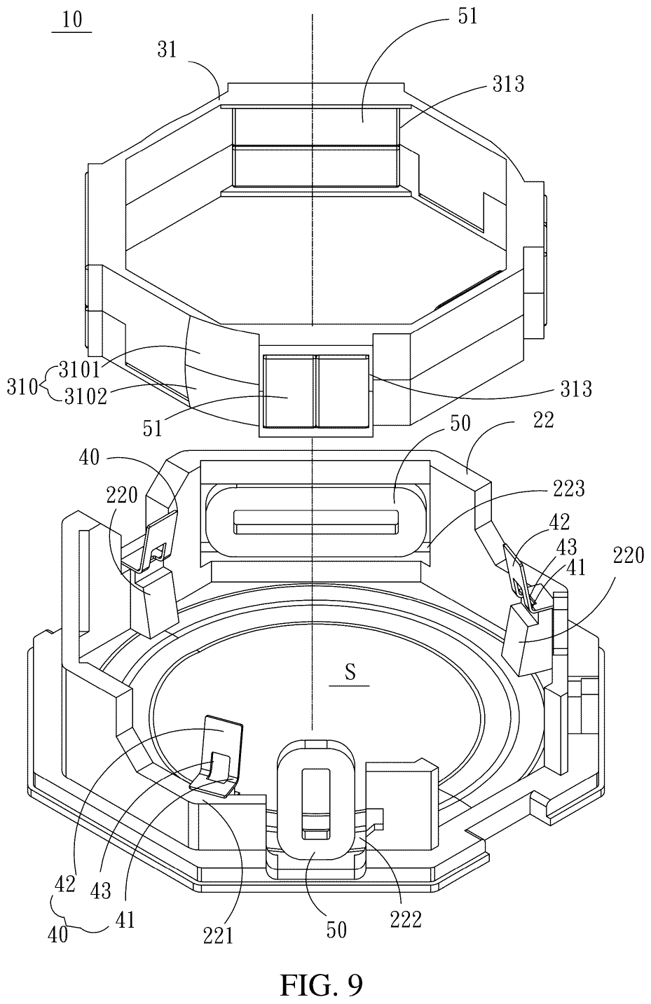

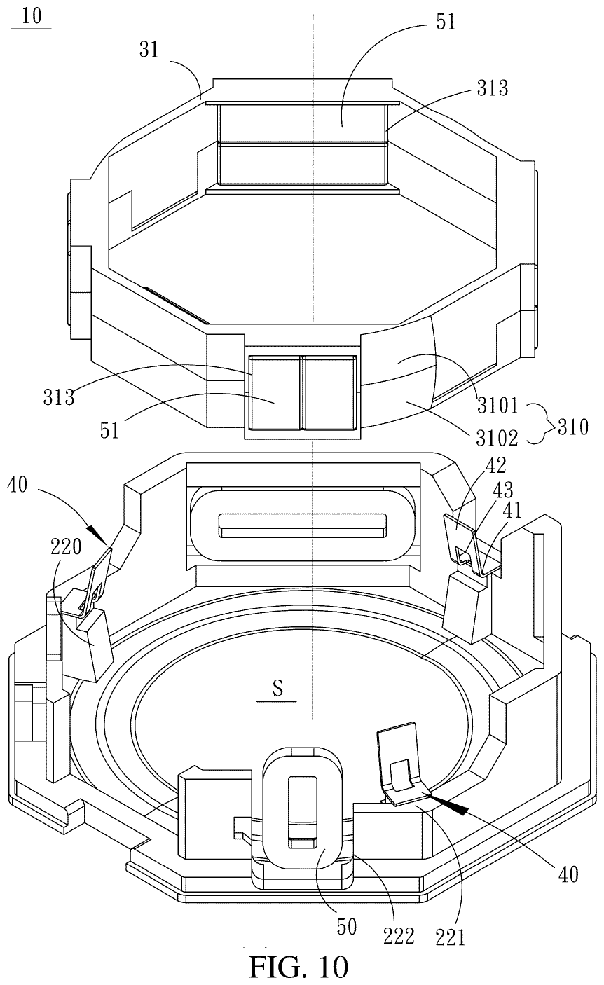

In this embodiment, the abutting surface 310 includes an upper abutting surface 3101 and a lower abutting surface 3102. The upper abutting surface 3101 extends from the top of the second annular sidewall 31 toward the lower abutting surface 3102, the lower abutting surface 3102 extends from the bottom of the second annular sidewall 31 toward the upper abutting surface 3101, the upper abutting surface 3101 and the lower abutting surface 3102 cooperatively form the spherical surface, and the contact surface 220 contacts the lower abutting surface 3102. In this embodiment, as shown in FIG. 4, FIG. 5, FIG. 6, FIG. 7, FIG. 8, FIG. 9 and FIG. 10, the optical stabilization structure 10 further includes a piece of elastic piece 40 disposed on the fixing component 20 and contacting the abutting surface 310 of the outer sidewall of the movable component 30. Specifically speaking, one end of the elastic piece 40 is disposed on the top of the fixing part 221 of the fixing component 20 and extends toward the outer sidewall of the second annular sidewall 31, and the elastic piece 40 bends to form a bend part 41 accordingly. After the bend part 41 is constituted, an another end of the elastic piece 40 is constituted by extending along the outer sidewall of the second annular sidewall 31. The another end of the elastic piece 40 has an elastic abutting surface 42 being the plane, the upper abutting surface 3101 contacts the elastic abutting surface 42 by the point contact, and the upper abutting surface 3101 is configured to be slidable relative to the elastic abutting surface 42. In this embodiment, one end of the elastic piece 40 is connected to the top of the fixing part 221 of the fixing component 20 by locks, adhesive or welding so that the elastic abutting surface 42 of the elastic piece 40 may provide the abutting surface 310 to relatively slide.

In this embodiment, the elastic piece 40 includes a through hole 43 disposed on the bend part 41 and a portion passing through the bend part 41. By the through hole 43, the elastic piece 40 bends easily and maintain appropriate elasticity when bending.

Additionally, the quantity of the elastic piece 40 matches that of the fixing part 221. In this embodiment, the quantity of t elastic piece 40 is three, and the three elastic pieces 40 are equidistant from each other; the quantity of the fixing part 221 is three, and the three fixing part 221 are equidistant from each other; the quantity of the contact surface 220 is three, and the three contact surfaces 220 are equidistant from each other.

In this embodiment, the optical stabilization structure 10 further includes a plurality of coils 50 and a plurality of sets of magnetic elements 51, some of the plurality of coils 50 are inserted in the coil insertion part 222 and some of plurality of sets of magnetic elements 51 are embedded in the coil embedding part 223, and the plurality of sets of magnetic elements 51 are disposed on the accommodating part 313.

Furthermore, some of the plurality of sets of magnetic elements 51 are orthogonally disposed with the second annular sidewall 31 in the accommodating part 313, and some of the plurality of sets of magnetic elements 51 are horizontally disposed with the second annular sidewall 31 in the accommodating part 313. Some of the plurality of sets of magnetic elements 51 are orthogonally disposed with the second annular sidewall 31 in the accommodating part 313 and corresponds to the coil insertion part 222, and some of the plurality of sets of magnetic elements 51 are horizontally disposed with the second annular sidewall 31 in the accommodating part 313 and corresponds to the coil embedding part 223. In this embodiment, each set of magnetic elements 51 is composed of two magnetic elements arranged in parallel. In the aforementioned embodiments, by the three positions by the point contact and the three elastic pieces, the position, the area, and the force of the contact surface maintain stable during the operation process and the coefficient of friction and the positive force are stable to ensure the smooth operation process of the optical stabilization structure. This ensures a stable coefficient of friction, consistent forward force, and guarantees a smooth operation process.

Through the above configuration, the fixing component and the movable component of the present application contact with each other by the point contact so that the contact position, the contact area, and the contact force are stable to achieve the purpose of enhancing product performance.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. An optical stabilization structure, comprising:
a fixing component providing an accommodating space, and the fixing component comprising:
a bottom plate;
a first annular sidewall of which a bottom is adjacent to the bottom plate, wherein the bottom of the first annular sidewall is orthogonally connected to the bottom plate to constitute the accommodating space, and an inner sidewall of the first annular sidewall has a contact surface;
a movable component disposed in the accommodating space, and the movable component comprising:
a second annular sidewall disposed in the accommodating space, wherein an outer sidewall of the second annular sidewall has an abutting surface;
wherein the abutting surface matches the contact surface by point contact, and the abutting surface is configured to be slidable relative to the contact surface.

2. The optical stabilization structure as claimed in claim 1, wherein the contact surface is a plane, and the abutting surface is a spherical surface.

3. The optical stabilization structure as claimed in claim 1, wherein the contact surface is a spherical surface, and the abutting surface is a plane with a protruding point.

4. The optical stabilization structure as claimed in claim 2, wherein the second annular sidewall comprises an upper annular sidewall and a lower annular sidewall, the upper annular sidewall has an upper trench, the lower annular sidewall has a lower trench, and an opening of the upper trench matches an opening of the lower trench to constitute an accommodating part.

5. The optical stabilization structure as claimed in claim 4, further comprising: an elastic piece disposed on the fixing component and contacting the abutting surface elastically.

6. The optical stabilization structure as claimed in claim 5, wherein one end of the elastic piece is disposed on the fixing component and extends toward an outer sidewall of the second annular sidewall, and the elastic piece bends to constitute a bend part accordingly, and after constituting the bend part, the elastic piece extends along the outer sidewall of the second annular sidewall to constitute an another end of the elastic piece.

7. The optical stabilization structure as claimed in claim 6, wherein the another end of the elastic piece has an elastic abutting surface which is a plane, the abutting surface contacts the elastic abutting surface by the point contact, and the abutting surface is configured to be slidable relative to the elastic abutting surface.

8. The optical stabilization structure as claimed in claim 5, wherein a number of elastic piece is three, and the three elastic pieces are equidistant from each other; a number of contact surfaces is three, and the three contact surfaces are equidistant from each other.

9. The optical stabilization structure as claimed in claim 5, wherein the first annular sidewall has a fixing part, the fixing part is constituted by recessing from a top of a part of the first annular sidewall to the bottom of the first annular sidewall, the contact surfaces is disposed on an inner sidewall of the fixing part, and the elastic piece is disposed on a top of the fixing prat.

10. The optical stabilization structure as claimed in claim 6, wherein the elastic piece comprises a through hole disposed at the bend part and passing through a portion of the bend part.

11. The optical stabilization structure as claimed in claim 7, wherein the abutting surface comprises an upper abutting surface and a lower abutting surface, the upper abutting surface extends from a top of the second annular sidewall to the lower abutting surface, the lower abutting surface extends from a bottom of the second annular sidewall to the upper abutting surface, the upper abutting surface and the lower abutting surface cooperatively form the spherical surface, the upper abutting surface contacts the elastic abutting surface by the point contact, and the contact surface contacts the lower abutting surface.

12. The optical stabilization structure as claimed in claim 9, wherein the first annular sidewall has a coil insertion part and a coil embedding part, the coil insertion part is constituted by recessing from a portion of the top of the first annular sidewall to the bottom of the first annular sidewall, and the coil embedding part is constituted by passing through the first annular sidewall.

13. The optical stabilization structure as claimed in claim 12, wherein the coil embedding part and the coil insertion part are relatively disposed, and the coil insertion part and the coil embedding part are positioned between the fixing part, and the coil insertion part and the coil embedding part correspond to the accommodating part.

14. The optical stabilization structure as claimed in claim 13, further comprising:
a plurality of coils, wherein some of the plurality of coils are inserted in the coil insertion part and some of the plurality of coils are embedded in the coil embedding part; and
a plurality of sets of magnetic elements disposed on the accommodating part.

15. The optical stabilization structure as claimed in claim 14, wherein some of the plurality of sets of magnetic elements are orthogonally disposed with the second annular sidewall in the accommodating part, and some of the plurality of sets of magnetic elements are horizontally disposed with the second annular sidewall in the accommodating part.

16. The optical stabilization structure as claimed in claim 15, wherein some of the plurality of sets of magnetic elements are orthogonally disposed with the second annular sidewall in the accommodating part and corresponds to the coil insertion part, and some of the plurality of sets of magnetic elements are horizontally arranged with the second annular sidewall in the accommodating part and corresponds to the coil embedding part.
